(19) United States
(12) Patent Application Publication
(10) Pub. No.: US 2007/0182151 A1
(43) Pub. Date: Aug. 9, 2007

(54) Wheel well and undercarriage protector for vehicles

(76) Inventor: Keith Robert Aulabaugh, Brewster, NY (US)

Correspondence Address: AHSAN & ASSOCIATES, P.O. BOX 251, HOPEWELL JUNCTION, NY, 12533, US

(21) Appl. No.: 11/349,274

(22) Filed: Feb. 7, 2006

(51) Int. Cl. B62D 25/18

(52) U.S. Cl. 280/849

(57) ABSTRACT

The present invention relates generally to a wheel well and undercarriage protector for vehicles, such as trucks. More particularly, the invention encompasses a method and an apparatus for year-round fender protection for vehicles, such as, trucks, and especially during winter and rainy conditions. The invention further includes the option for a splash guard. The fender protectors also add to the aesthetics of the truck.

### FIELD OF THE INVENTION

The present invention relates generally to a wheel well and undercarriage protector for vehicles, such as trucks. More particularly, the invention encompasses a method and an apparatus for year-round fender protection for vehicles, such as, trucks, and especially during winter and rainy conditions. The invention further includes the option for a splash guard. The fender protectors also add to the aesthetics of the truck.

### BACKGROUND INFORMATION

In the automotive industry, both the owners and the manufacturers, use different types of innovations to protect and extend the life of their vehicles. For example, some vehicles are provided with fender attachments. Some of the fender attachments are strictly for cosmetic purposes for the outside of the vehicle, while other fender attachments are there to prevent dings from rocks and stones and other road debris that gets kicked-up by the rotation of the tire. However, none of such improvements address the need to protect the undercarriage or the wheel well of the vehicle.

The prior art is also replete with inventions that have extended and enhanced the protection of the vehicle bodies. For example, U.S. Pat. No. 5,435,630 (Tucker) relates to devices for protecting vehicle parts during cleaning. More specifically, the invention relates to devices or shields for protecting vehicle wheel rims when cleaning vehicle tires, where a protective covering device suitable for protecting the surface of the wheel rim of an automobile against damage by toxic cleaning solutions used to clean the surrounding tire is applied. The shield is temporarily attached to the rim with a grasping device which provides assistance to the user who is holding the protective device over the rim while applying cleaning solution to the surrounding tire.

U.S. Pat. No. 6,044,968 (Iampen) relates to the field of covers for mounting on tires, and in particular, to flexible covers for mounting over exposed outer sidewalls of a tire when the tire is in a static position, for example, when a vehicle is parked and the tire is supporting the vehicle. The tire protective cover protects the static mounted tire from environmental hazards, wherein the environmental hazards include ultra-violet radiation and air-borne contaminants such as, corrosive fluids or paint protection from dogs urinating on rims and tires. The tire cover includes a resilient casing for covering a side of a tire, wherein the resilient casing covering the one side of the tire has a generally circular member having a radially adjacent series of sequentially raised concentric annular surfaces. Lugs are provided for gripping, and structurally reinforcing, the concentrically inner, center portion of the cover.

U.S. Pat. No. 6,193,278 (Ward, et al.) discloses an automotive vehicle splash guard, where the splash guard includes a generally flat and flexible mounting component contoured to be mounted in a wheel well of any vehicle of a class of vehicles and a contoured member shaped to provide body panel engagement with at least one selected vehicle but not all vehicles of the class. The member and the component have engaging portions which are contoured complementally such that when the member and the component are secured together the member and the component together give the appearance of a unitary splash guard custom molded to fit such at least one selected vehicle of the class. A process for making customized splash guards is also disclosed.

U.S. Pat. No. 6,260,911 (Becker) discloses an air duct for cooling rotating tires that broadly funnels or directs air up and into the face of an air fender or rotating tire. The air duct comprises a depending wall having an upper and a bottom edge. Formed within the wall is a leading tunnel section in communication with a baffle section, the tunnel section having a discharge end. The tunnel section defines at least one flow path which channel ambient air through the discharge end and into the baffle section where the air is subsequently directed into the face of air fender or rotating tire. The baffle section is defined as being between the discharge end of the tunnel section and either the leading surfaces of an air fender or where there is no fender, or the leading surfaces of the associated tire.

U.S. Pat. No. 6,554,306 (Gaspar) discloses a wheel protection device for a vehicle for preventing flying debris from striking the rear tire. The wheel protection device includes a mounting bracket for mounting on the front portion of the fender of the vehicle; and a debris deflection member being attached to the mounting bracket and being adapted to extend below the fender of the vehicle forward of the wheel when the mounting bracket is mounted on the front portion of the fender. The debris deflection member has a curved outer surface for orienting in a forward direction on the vehicle to deflect debris laterally of a path of the wheel.

United States Patent Application No. 20040140664 (Ward) where a splash guard assembly for an over the highway vehicle and a kit for making the assembly are disclosed. The assembly includes a contoured splash guard and an intermediate mounting element for positioning between the splash guard and a vehicle side panel. The guard and the element are complementally contoured to fit together. The element is also contoured to fit a specific vehicle panel adjacent a wheel well of a vehicle having such panel. When assembled the element and panel are interconnected to enable mounting of the guard. Fasteners secure the element and guard together and the element to the panel.

The prior art has not addressed the problem of sand, salt, and road debris that gets kicked-up during the tire rotation and damages the undercarriage, wheel well, fenders and other body parts of a vehicle, including kicking the said debris onto a closely following vehicle. Thus, there exists a need to protect the fenders, the wheel well and the undercarriage of a vehicle from road elements, especially, during the winter and rain, including the safety and protection of a closely following vehicle from such flying projectiles.

This invention overcomes the problems of the prior art. The invention provides an option for the mechanically inclined operator of a vehicle, or the manufacturer, to mount the inventive fender protector as needed to protect the fenders, especially, during the winter months when salt and sand is applied on the roads and highways, or during the period of rain or when going through a terrain where road debris may be kicked-up to damage various vehicle body parts.

### PURPOSES AND SUMMARY OF THE INVENTION

This invention is a novel method and an apparatus for wheel well and undercarriage protection for vehicles, such as trucks.

Therefore, one purpose of this invention is to provide at least one fender protector above at least one tire of a vehicle.

Another purpose of this invention is to provide a method and an apparatus for the protection of vehicles during winter and/or rain.

Yet another purpose of this invention is to include a splash guard as part of the inventive vehicle protection.

Therefore, in one aspect this invention comprises a wheel well and undercarriage protector for a vehicle, comprising:

(a) a contoured fender, wherein said contoured fender has a substantially contoured portion, wherein said contoured portion has at least one first extended edge to securely accommodate at least one securing means; and

(b) at least one means to secure said at least one securing means to a portion of said vehicle, such that at least a portion of said contoured fender rides above a tire of said vehicle.

In another aspect this invention comprises a method of mounting a wheel well and undercarriage protector for a vehicle, comprising:

(a) securing at least one securing means to a contoured fender, wherein said contoured fender has a substantially contoured portion, wherein said contoured portion has at least one first extended edge to securely accommodate said at least one securing means; and

(b) securely securing said contoured fender to a portion of said vehicle, such that at least a portion of said contoured fender rides above a tire of said vehicle.

### BRIEF DESCRIPTION OF THE DRAWINGS

The features of the invention believed to be novel and the elements characteristic of the invention are set forth with particularity in the appended claims. The drawings are for illustration purposes only and are not drawn to scale. Furthermore, like numbers represent like features in the drawings. The invention itself, both as to organization and method of operation, may best be understood by reference to the detailed description which follows taken in conjunction with the accompanying drawings in which:

FIG. 1 is a side view of a rear wheel area of a vehicle which is used to illustrate one embodiment of the present invention.

FIG. 2 is a top view of the embodiment of the invention as illustrated in FIG. 1.

FIG. 3 is a sectional view taken along section A-A from FIG. 1.

FIG. 4 is a detailed side view of the inventive bracket assembly for the invention as shown in FIG. 1.

FIG. 5 is a side view of a rear wheel area of a vehicle which is used to illustrate a second embodiment of the present invention.

FIG. 6 is a side view of a front wheel area of a vehicle which is used to illustrate a third embodiment of the present invention.

FIG. 7 is a top view of the embodiment of the invention as illustrated in FIG. 5.

FIG. 8 is a detailed angular view of the inventive bracket assembly of the embodiment of the invention as shown in FIG. 6.

### DETAILED DESCRIPTION

The present invention is basically directed to a contoured fenders for vehicles, especially, trucks. The trucks are usually an expensive piece of equipment, and thus most of the owners and operators make all sorts of attempts to protect and extend the life and beauty of their vehicle. This protection becomes all the more important, especially, during the winter months when salt and sanding not only soils the vehicle but also corrodes the metal parts of the vehicle especially due to the flying debris from the tires.

The inventive contoured fender not only substantially reduces the exposure of the vehicle to the road salt and sand, but also contains the road salt, sand and other debris within a confined area. The inventive fender also dresses up the truck.

The inventive contoured fender preferably follows the contours of the tire and is preferably attached to the axle or spindle so that it will move with the steering and suspension movement of the truck. Thus, the inventive contoured fender can be installed in any truck without having to modify any wheel well or fender area or any steering mechanisms in any substantial way. The inventive fender is also designed to be active with the suspension and steering mechanism of the vehicle such that it maintains alignment and movement with the suspension and steering movement of the tire.

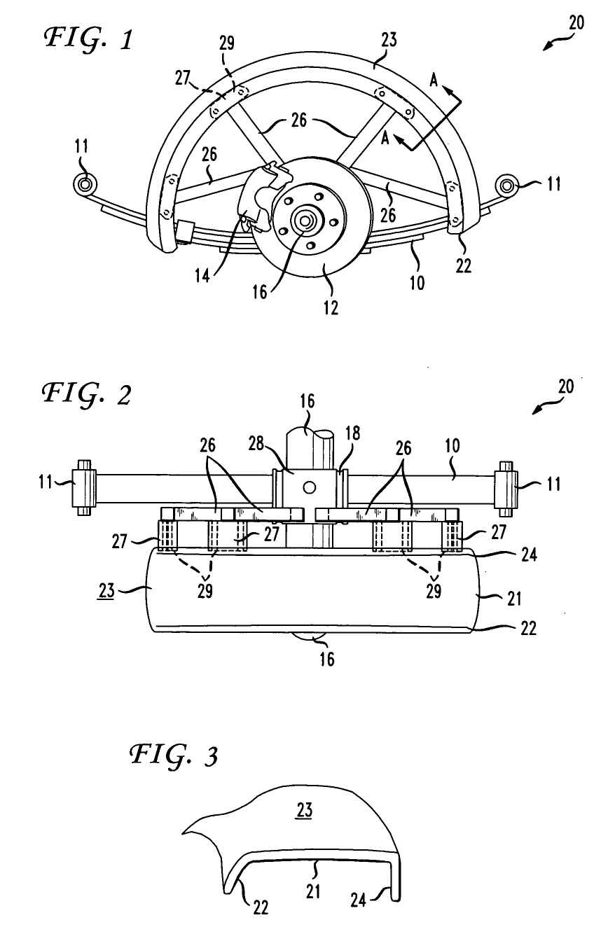

FIG. 1 is a side view of a rear wheel area 20, of a vehicle which is used to illustrate one embodiment of the present invention. The rear wheel area 20, typically has a leaf spring 10, with mounting brackets 11, along with axle rod 16, which is used to mount a tire rim (not shown), brake rotor 12 and brake pad assembly 14. Inventive contoured fender 23, is mounted in the rear wheel area 20 using a plurality of braces 26, as more clearly illustrated in FIG. 2.

FIG. 2 is a top view of the embodiment of the invention as illustrated in FIG. 1, where a first end of the brace 26 is secured to an edge 24, of the fender 23, and a second end of the brace 26, is secured to either a portion of the axle rod 16 or to a bracket 28, which is preferably secured above the leaf spring 10. It is preferred the first end of the brace 26, be secured to the inner edge 24, of the fender 23, using at least one spacer block 27. The fender 23, preferably has a substantially contoured area 21, with a first edge or lip extension 22, and a second edge or lip extension 24, as more clearly illustrated in FIG. 3.

FIG. 3 is a sectional view taken along section A-A from FIG. 1, showing an enlarged view of the contoured fender 23, having a substantially contoured area 21, with the first edge or lip extension 22, and the second edge or lip extension 24. The contoured fender 23, could be made from a material selected from a group consisting of metal, aluminum, steel, rubber, plastic, polymer based material, polyethylene material, composite material, multi-layered material, to name a few. It is preferred that the material for the contoured fender 23, is corrosion resistant as it will be exposed to sand, salt and other road debris. It is also preferred that the material that is selected for the contoured fender 23, can operate at temperatures from about 100 degrees below zero to about 200 degrees above zero Fahrenheit, and preferable from about zero degrees to about 110 degrees Fahrenheit.

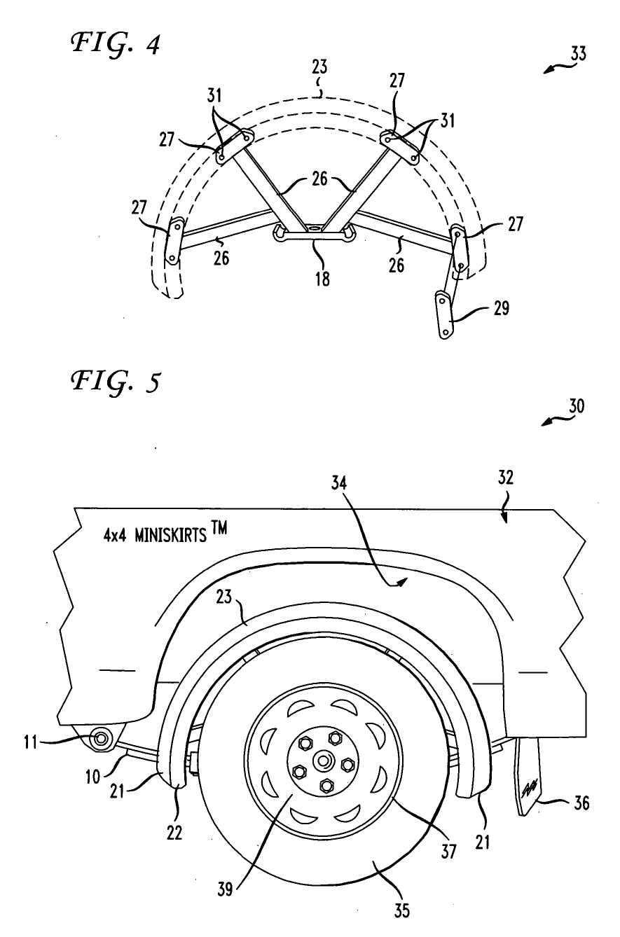

FIG. 4 is a detailed side view of the inventive bracket assembly 33, for the invention as shown in FIG. 1, where the mounting plate 18, is secured by the existing rear-axle u-bolts (not shown) along the leaf spring 10. For installation the u-bolts are loosened only to remove the factory leaf spring retainer plate (not shown) to install the new retainer plate 18, of bracket assembly 33. This inventive assembly 33, is preferably a one piece unit. The existing u-bolts are then re-torqued to factory specifications. The fender 23, can now be installed to the spacer mounts 27, and fastened with the corresponding retainers or spreaders 29, using bolt fasteners 31, for each spreader or retainer 29. It should be noted that the inventive assembly 33, may have to be modified or adapted to meet the wheel well requirements for different model vehicles or trucks. The inventive bracket assembly 33, may be painted with an epoxy primer/sealer with a rust inhibitor and top coated with preferably a single stage urethane paint, such as, a black paint, or an acrylic enamel.

FIG. 5 is a side view of a rear wheel area 30, of a vehicle 32, which is used to illustrate a second embodiment of the present invention. As illustrated the rear wheel area 30, of the vehicle 32, shows a wheel well 34, and a tire 35, having a tire rim 37, mounted on an axle rod (not shown). The tire 35, could also be provided with a hub cap 39 or a decorative tire rim 39. The contoured fender 23, is secured to the axle 16, inside of the wheel well 34, such that it rides just above the tire 35, and that there is a consistent clearance between the contoured fender 23, and the extreme outer edges of the tire 35. The vehicle 32, could also have a mud flap or splash guard 36, secured to the wheel well area 34.

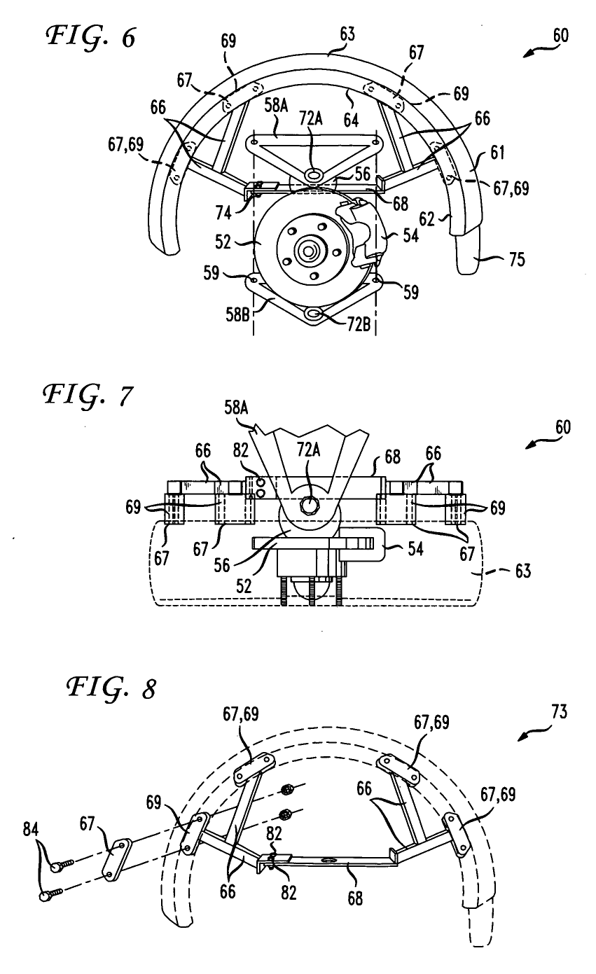

FIG. 6 is a side view of a front wheel area 60, of a vehicle which is used to illustrate a third embodiment of the present invention. The front wheel area 60, typically has an upper control arm 58A, and a lower control arm 58B, and upper ball joints 72A, and lower ball joints 72B, which mount to the axle/spindle 56 with mounting brackets or bushing 59, along with axle or spindle 56, which is used to mount a tire rim (not shown), brake rotor 52, and brake pad assembly 54. The inventive contoured fender 63, is mounted to the front wheel spindle 56, using a plurality of braces 66, as more clearly illustrated in FIG. 7. The mounting of the fender 63, to the spindle 56, also results in the contoured fender 63, to stay in excellent alignment with the tire 35, in any left or right steering position.

FIG. 7 is a top view of the embodiment of the invention as illustrated in FIG. 5, where a first end of the brace 66 is secured to an edge 64, of the fender 63, and a second end of the brace 66, is secured to either a portion of the axle/spindle 56 or to a bracket 74, which is preferably secured to the axle/spindle 56. The mounting plate 68, will turn left and right with the steering as it is mounted to the spindle/axle 56. It is preferred the first end of the brace 66, be secured to an inner edge 64, of the fender 63, using at least one spacer block 67. The fender 63, preferably has a substantially contoured area 61, with a first edge or lip extension 62, and a second edge or lip extension 64, similar to the contoured fender 23, as illustrated in FIG. 3. The contoured fender 63, could also have an integrated splash guard 75, or a splash guard 75, could be secured to the fender 63.

FIG. 8 is a detailed angular view of the inventive bracket assembly 73, of the embodiment of the invention as shown in FIG. 6. The bracket assembly 73 is a two piece unit for installation purposes only. It is fastened together at the mounting base 68, by preferably two fastener bolts 82. The mounting base plate 68, is fastened to the spindle 56, by the upper ball joint castle nut (not shown). The castle nut must be removed to install the base plate 68 and secured with the castle nut and re-torqued to the vehicle's specifications. The mounting base 68, can now be installed and preferably secured with two fasteners 82, and torqued to specifications. The fender 63, is mounted to the spacer mount 67, with a retainer plate or spacer block or fender mounting surface 69, and preferably secured with two fasteners 84 for each spreader retainer 67. The mounting plate 68, is preferably gusseted on the inner side for strength and is also designed to be able to service brakes without the complete removal of the assembly unit 73.

The extended lip/edge 22, 24, 62, 64, of the fender 23, 63, provides a superior control of the water spray and other projectiles, such as, sand, salt, road debris from hitting and damaging the vehicle fenders, wheel wells and undercarriage and assists in keeping the vehicle clean.

This invention allows the vehicle owners, especially, truck owners to be able to preserve their vehicles by greatly reducing the exposure to road salt and sand, which will ultimately help prevent their vehicles from rusting and ultimately extending the life of the vehicle, such as a truck.

The contoured inventive fender also preserves the vehicle by substantially reducing road salt and sand from being propelled off of the vehicle tires and into the wheel well and also the undercarriage of the vehicle to help prevent corrosion due to exposure from the elements. Also, the vehicle, especially, the undercarriage and the areas around the wheel well will remain substantially clean while driving the vehicle with the inventive fender under muddy and snowy conditions.

The need to clean the vehicle will be substantially reduced with this invention. These inventive protectors also greatly add to the aesthetics of the vehicle.

Upon filing of the instant patent application the inventive wheel well and undercarriage protector will be available at www.4×4miniskirts.com under the trademark 4×4MINISKIRTS™.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A wheel well and undercarriage protector for a vehicle, comprising:
(a) a contoured fender, wherein said contoured fender has a substantially contoured portion, wherein said contoured portion has at least one first extended edge to securely accommodate at least one securing means; and
(b) at least one means to secure said at least one securing means to a portion of said vehicle, such that at least a portion of said contoured fender rides above a tire of said vehicle.

2. The wheel well and undercarriage protector for a vehicle of claim 1, wherein said contoured fender has a second extended edge.

3. The wheel well and undercarriage protector for a vehicle of claim 1, wherein the material for said contoured fender is selected from a group consisting of metal, aluminum, steel, rubber, plastic, polymer based material, polyethylene material, composite material and multi-layered material.

4. The wheel well and undercarriage protector for a vehicle of claim 1, wherein the material for said contoured fender is selected from a group consisting of a corrosion resistant material and a flexible material.

5. The wheel well and undercarriage protector for a vehicle of claim 1, wherein the material for said contoured fender can withstand temperatures from about 100 degrees below zero to about 200 degrees above zero Fahrenheit, and preferable from about zero to about 100 degrees above zero Fahrenheit.

6. The wheel well and undercarriage protector for a vehicle of claim 1, wherein said fender is formed from a material coatable with an automotive finish and compatible with the finish to retain that finish over the life of said fender.

7. The wheel well and undercarriage protector for a vehicle of claim 1, wherein said fender may be colored to match at least one color in said vehicle.

8. The wheel well and undercarriage protector for a vehicle of claim 1, wherein at least one spreader retainer is secured between a spacer block and an edge of said contoured fender.

9. The wheel well and undercarriage protector for a vehicle of claim 1, wherein there is a consistent clearance between said contoured fender and the extreme outer edge of a tire.

10. The wheel well and undercarriage protector for a vehicle of claim 1, wherein said contoured fender actively follows the suspension and steering movements of said vehicle.

11. A method of mounting a wheel well and undercarriage protector for a vehicle, comprising:
(a) securing at least one securing means to a contoured fender, wherein said contoured fender has a substantially contoured portion, wherein said contoured portion has at least one first extended edge to securely accommodate said at least one securing means; and
(b) securely securing said contoured fender to a portion of said vehicle, such that at least a portion of said contoured fender rides above a tire of said vehicle.

12. The method of mounting a wheel well and undercarriage protector for a vehicle of claim 11, wherein said contoured fender has a second extended edge.

13. The method of mounting a wheel well and undercarriage protector for a vehicle of claim 11, wherein the material for said contoured fender is selected from a group consisting of metal, aluminum, steel, rubber, plastic, polymer based material, polyethylene material, composite material and multi-layered material.

14. The method of mounting a wheel well and undercarriage protector for a vehicle of claim 11, wherein the material for said contoured fender is selected from a group consisting of a corrosion resistant material and a flexible material.

15. The method of mounting a wheel well and undercarriage protector for a vehicle of claim 11, wherein the material for said contoured fender can withstand temperatures from about 100 degrees below zero to about 200 degrees above zero Fahrenheit, and preferable from about zero to about 100 degrees above zero Fahrenheit.

16. The method of mounting a wheel well and undercarriage protector for a vehicle of claim 11, wherein said fender is formed from a material coatable with an automotive finish and compatible with the finish to retain that finish over the life of said fender.

17. The method of mounting a wheel well and undercarriage protector for a vehicle of claim 11, wherein said fender may be colored to match at least one color in said vehicle.

18. The method of mounting a wheel well and undercarriage protector for a vehicle of claim 11, wherein at least one spreader retainer is secured between a spacer block and an edge of said contoured fender.

19. The method of mounting a wheel well and undercarriage protector for a vehicle of claim 11, wherein there is a consistent clearance between said contoured fender and the extreme outer edge of a tire.

20. The method of mounting a wheel well and undercarriage protector for a vehicle of claim 11, wherein said contoured fender actively follows the suspension and steering movements of said vehicle.
